(19) United States
(12) Patent Application Publication
(10) Pub. No.: US 2015/0019960 A1
(43) Pub. Date: Jan. 15, 2015

(54) Document Editing Apparatus, Non-Transitory Computer-Readable Recording Medium and Document Editing Method

(71) Applicant: Konica Minolta, Inc., Tokyo (JP)

(72) Inventors: Kiyohiko Kobayashi, Tokyo (JP); Tetsuhiro Shibata, Shizuoka (JP); Keiichiro Hyodo, Tokyo (JP); Masayuki Inoue, Tokyo (JP)

(21) Appl. No.: 14/326,365

(22) Filed: Jul. 8, 2014

(30) Foreign Application Priority Data
Jul. 10, 2013 (JP) 2013-144180

(51) Int. Cl. G06F 17/24

(52) U.S. Cl. CPC G06F 17/24
USPC 715/256

(57) ABSTRACT

Disclosed is a document editing apparatus in which in case that the undo and redo instruction unit receives the instruction to perform the undo operation, the editing unit performs the undo operation by tracing back only the history data of the editing operation performed in the range displayed on the display unit when the instruction to perform the undo operation is received, among the history data stored in the storage unit, and in case that the undo and redo instruction unit receives the instruction to perform the redo operation, the editing unit performs the redo operation by tracing back only the history data of the editing operation performed in the range displayed on the display unit when the instruction to perform the redo operation is received, among the history data stored in the storage unit.

### BACKGROUND OF THE INVENTION

1. Field of the Invention

The present invention relates to a document editing apparatus having undo and redo functions, a non-transitory computer-readable recording medium and a document editing method.

2. Description of Related Art

Most of document editing apparatuses have a function of storing history data of editing operations received from a user, undoing previously-performed editing operations in order from the newest editing operation by tracing back in time sequence, and redoing the undone editing operations (canceling an undo operation).

Normally, a document editing apparatus has an undo button and a redo button, and when the undo button is operated once, the newest editing operation is canceled and the editing state is returned to a previous state. Further, when the undo button is repeatedly operated, the editing operations are continuously canceled so as to trace back in time sequence. Likewise, when the redo button is pressed down, the editing operation canceled by the newest undo operation is performed again. Further, when the redo button is continuously operated, a plurality of the editing operations canceled by the undo operation are performed again in the reverse order which is reverse to the order of the undo operation, and the editing state can be returned to a state before the cancel of the editing operations.

Japanese Patent Application Publication No. 2010-515516 discloses an undo and redo system capable of specifying a given past time by using a slider bar or the like and returning to editing contents at the specified time for the purpose of saving time and effort for repeating an operation of the undo button or the like.

Further, there is a problem that in general, when characters are deleted or added by the undo operation and then a new input is performed, the characters deleted or added by the undo operation cannot be restored any more. As a technology for dealing with the above-described problem, Japanese Patent Application Publication No. 2008-257318 discloses a technology capable of additionally recording the undo operation itself also as new history data of an editing operation, and restoring a character input state at a given past time by tracing back the additional record in order.

In case that a document having a plurality of pages is edited, when an editing operation such as addition or deletion of characters is performed in a certain page, a user is sometimes aware of an error in editing contents of other pages in which editing operations have been performed. At this time, when the undo function is used in order to correct the error, the editing operations are canceled in order by tracing back from the current time in time sequence. Accordingly, before the editing operation in a target page is undone, the editing operation performed in the current page also is canceled.

Even if the technologies disclosed in Japanese Patent Application Publications Nos. 2010-515516 and 2008-257318 are used, the above-described problem is not solved.

Regardless of the page, for example, also in case that part of a certain page is enlarged and displayed to perform editing operations, the same problem is caused. That is, also in case that a user wants to undo the editing operation performed in another range in the past without cancelling the editing operation in the range which is enlarged and is currently displayed, the same problem is caused.

### SUMMARY

To achieve at least one of the abovementioned objects, a document editing apparatus reflecting one aspect of the present invention comprises:

a display unit configured to display a range which is a part of a document;

a displayed range switching unit configured to switch the range displayed on the display unit;

an operating unit configured to receive an editing operation for the document;

an editing unit configured to edit the document in accordance with the editing operation received by the operating unit;

a storage unit configured to store history data of the editing operation for the document; and

an undo and redo instruction unit configured to receive an instruction to perform an undo operation for the editing operation performed by the editing unit, and an instruction to perform a redo operation for the editing operation performed by the editing unit,

wherein in case that the undo and redo instruction unit receives the instruction to perform the undo operation, the editing unit performs the undo operation by tracing back only the history data of the editing operation performed in the range displayed on the display unit when the instruction to perform the undo operation is received, among the history data stored in the storage unit, and

in case that the undo and redo instruction unit receives the instruction to perform the redo operation, the editing unit performs the redo operation by tracing back only the history data of the editing operation performed in the range displayed on the display unit when the instruction to perform the redo operation is received, among the history data stored in the storage unit.

Preferably, the storage unit stores the history data for each range.

Preferably, the range is an arbitrary one page of the document.

Preferably, the range is an area which is a part of an arbitrary one page of the document.

Preferably, the editing operation includes a handwriting input.

Preferably, an upper limit of number of times of the undo operation in the range and an upper limit of number of times of the redo operation in the range are set.

Preferably, the document editing apparatus further comprises an upper limit changing unit configured to change each of the upper limits.

Preferably, the upper limit changing unit changes each of the upper limits in accordance with a remaining capacity of the storage unit.

Preferably, the storage unit is used also as a storage area for storing the document, and

the upper limit changing unit changes each of the upper limits in accordance with number of pages of the document stored in the storage unit.

Preferably, each of the upper limits is set for each range, and the upper limit changing unit increases each of the upper limits set for an arbitrary range in accordance with number of objects added to the arbitrary range.

Preferably, each of the upper limits is set for each range, and the upper limit changing unit changes each of the upper limits set for an arbitrary range in accordance with a size of a blank portion which is initially included in the arbitrary range of the document.

Preferably, each of the upper limits is set for each range, and the upper limit changing unit decreases each of the upper limits set for an arbitrary range as number of figures included in the arbitrary range of the document increases.

Preferably, the undo and redo instruction unit has a function of receiving a selection of an arbitrary one history data from the history data stored in the storage unit, and

the editing unit has a function of undoing or redoing the editing operation corresponding to the selected one history data.

Preferably, the storage unit stores the history data in a nonvolatile manner.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a plan view showing a document editing apparatus according to the embodiment;

FIG. 2 is a view showing an electric schematic configuration of the document editing apparatus;

FIG. 3 is a view showing a configuration example of an undo memory and a redo memory as a storage unit which stores history data of the editing operation in the document;

FIGS. 4 and 5 are a flowchart showing the process relating to the undo operation and the redo operation during a handwriting input, which is performed by the document editing apparatus;

FIGS. 6A, 6B, 7A and 7B are views showing a specific example of the operations in case that the undo operation and the redo operation are performed;

FIG. 8 is a view showing an example of the display range in case that the normal display is performed and an example of the display range in case that the enlargement display is performed in the document editing apparatus;

FIG. 9 is a view showing each state of the units in case that 10 strokes have been input in handwriting from the stroke “a” to the stroke “j” in order in the state of the normal display;

FIG. 10 is a view showing each state of the units in case that only the areas A and B are enlarged at 140% in the state shown in FIG. 9 and are displayed;

FIG. 11 is a view showing each state of the units in case that the undo operation is continuously received twice in the state shown in FIG. 10;

FIG. 12 is a view showing each state of the units in case that the redo operation is received once in the state shown in FIG. 11;

FIG. 13 is a view showing each state of the units in case that a new stroke “k” is input in handwriting in the area B in the state shown in FIG. 11;

FIG. 14 is a view showing each state of the units in case that the display state is returned to the normal display in the state shown in FIG. 13;

FIG. 15 is a view showing each state of the units in case that the undo operation is continuously received twice in the state shown in FIG. 14;

FIG. 16 is a view showing each state of the units in case that only the area A is enlarged at 200% in the state shown in FIG. 9 and is displayed; and

FIGS. 17 and 18 are a flowchart showing the process relating to the undo operation and the redo operation during the handwriting input, which is performed by the document editing apparatus having the enlargement display function.

### DETAILED DESCRIPTION OF PREFERRED EMBODIMENT

Hereinafter, a preferred embodiment of the present invention will be explained with reference to the accompanying drawings.

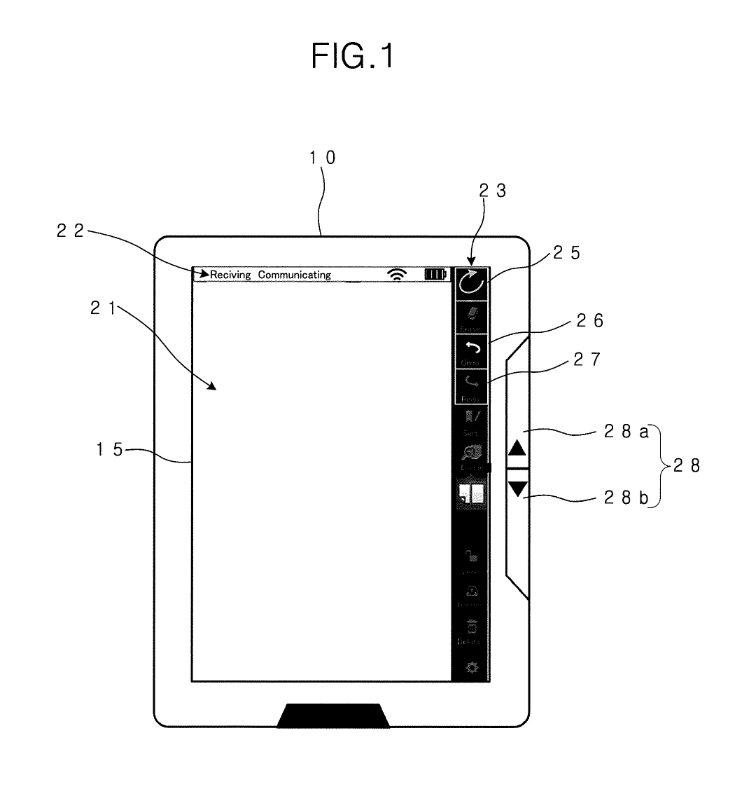

FIG. 1 is a plan view showing the document editing apparatus 10 according to the embodiment. The document editing apparatus 10 can wirelessly communicate with an external device which is, for example, an information processing apparatus, such as a personal computer or the like via a network such as a wireless LAN. Further, the document editing apparatus 10 has a function of receiving document data from the information processing apparatus and the like, displaying and editing the document, and adding a handwritten memo. Further, the document editing apparatus 10 has a function of transmitting a document which has been edited by adding the handwritten memo, to an external device such as the information processing apparatus or a printer. The document editing apparatus 10 is used for, for example, the revision, the correction, and the like of the documents to be printed.

The document editing apparatus 10 is a portable terminal having a plate shape of an approximate A4 size, and nearly the whole area of the surface thereof is a display surface of a display unit 15. The display unit 15 is a display device which can hold display contents without consumption of power, and which consumes the power when the display contents are rewritten. For example, the display unit 15 is configured by the electrophoretic type of electronic paper.

Further, on the display surface of the display unit 15, a touch panel which detects a position on which the display surface is touched by a finger, a pen, or the like is provided. On the display surface of the display unit 15 of the document editing apparatus 10, a page display area 21 in which the rewriting of the display contents is performed by an operation of a user, a system information area 22 in which the document editing apparatus 10 automatically updates the display contents, and a tool bar 23 are displayed. The system information area 22 is provided on the upper part of the display surface of the display unit 15, and the tool bar 23 is provided in a vertical band shape on the right edge of the display surface of the display unit 15. All of the display surface of the display unit 15 except the system information area 22 and the tool bar 23 is the page display area 21.

On the page display area 21, a document or an image to be browsed or edited is displayed page by page, or a part of the page is enlarged and displayed. Further, the user can add characters or figures in handwriting to the page display area 21.

On the system information area 22, information such as the time, the date, the radio field intensity of wireless communication, the battery residual capacity, and the like is displayed. The display contents of the system information area 22 are automatically updated by the system.

On the tool bar 23, a button for selecting various tools (a pen, a rubber eraser, and the like) for the handwriting input, a refresh button 25, an undo button 26, a redo button 27, and the like are displayed. The undo button 26 is an operation button for inputting an instruction to perform an undo operation once. The redo button 27 is an operation button for inputting an instruction to perform a redo operation once.

The undo operation is an operation for canceling a newest editing operation and returning to the editing state before the editing operation, and the redo operation is an operation for canceling a newest undo operation and returning to the editing state before the undo operation is performed. When the instruction to perform the undo operation is continued two or more times, a plurality of the editing operations are canceled in order by tracing back from the newest operation in time sequence. When the undo operation is performed two or more times and then the redo operation is continued two or more times, a plurality of the undo operations are canceled in order by tracing back from the newest undo operation in time sequence.

In the front face of the document editing apparatus 10, on the frame part at the right side position of the display unit 15, a page turning button 28 which receives an operation for switching a page displayed on the page display area 21 of the display unit 15 to a previous page or a next page (page turning operation) from the user is provided. The page turning button 28 is configured by a next page button 28a for forwarding a page displayed on the page display area 21 to the next page and a previous page button 28b for returning the page to a previous page.

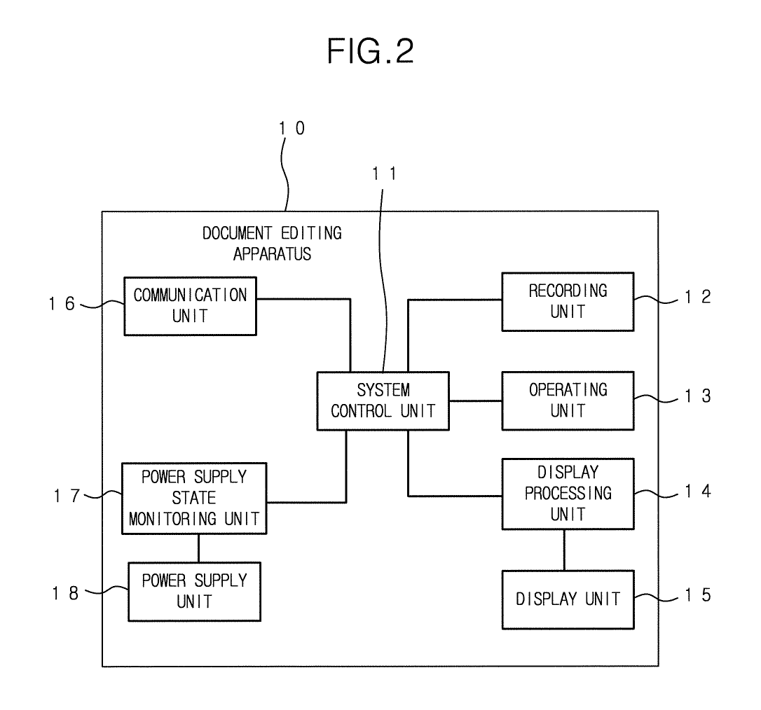

FIG. 2 shows an electric schematic configuration of the document editing apparatus 10. The document editing apparatus 10 comprises a system control unit 11 which totally controls the operations of the document editing apparatus 10, a recording unit 12, an operating unit 13, a display processing unit 14, a communication unit 16, and a power supply state monitoring unit 17, which are connected with the system control unit 11. The display unit 15 is connected subordinately to the display processing unit 14. A power supply unit (buttery) 18 for supplying power to each unit is provided.

The system control unit 11 controls the whole system, such as the control of the transmission and the reception of data, the storage of data, the control of reading out data, the control of displaying documents on the display unit 15, and the control of the reception of various operations or handwriting input from the user. The system control unit 11 comprises a CPU (Central Processing Unit), a ROM (Read Only Memory), and a RAM (Random Access Memory) as a main part. Further, by executing a program stored in the ROM, the function of the document editing apparatus 10 can be realized. The RAM is used as a work memory for temporarily storing various data when the CPU executes a program.

The recording unit 12 is a memory for storing data of documents or images to be displayed, the setting to be used in the system control, and the like. The recording unit 12 is a nonvolatile memory, and is used as a storage area (an undo memory and a redo memory which will be hereinafter described) for storing history data of the editing operation in a document.

The operating unit 13 has a function of receiving operations from the user, and is configured by key switches and a touch panel. Specifically, the operating unit 13 includes each button of the above-described tool bar 23, the page turning button 28, and the like.

The display processing unit 14 controls the display unit 15 to rewrite the display contents in accordance with the instruction of the system control unit 11. The display unit 15 is the above-described electrophoretic type of electronic paper. The display unit 15 is a so-called dot matrix type of display device in which pixels are arrayed in lengthwise and crosswise directions in a matrix form.

The communication unit 16 has a function to transmit and receive data to/from the external device. For example, the communication unit 16 has a function to receive data to be displayed, such as documents or images, and transmit the documents which have been edited by the document editing apparatus 10 or the data indicating handwritten contents to the external device.

The power supply state monitoring unit 17 has a function to monitor the state of the power supply unit 18, detect the residual quantity of suppliable power, and notify the system control unit 11 of the information relating to the state and the residual quantity. The power supply unit 18 is a power supply for supplying power to each unit of the document editing apparatus 10, and is configured by a secondary battery or the like, such as an alkaline storage battery or a lithium-ion battery.

Next, the undo function and the redo function of the document editing apparatus 10 will be explained.

In case that the instruction to perform the undo operation is received, the document editing apparatus 10 performs the undo operation by tracing back only the history data of the editing operation performed in the range (a page or a part enlarged and displayed in the page) displayed on the page display area 21 of the display unit 15 when the instruction of the undo operation is received, in time sequence. On the other hand, in case that the instruction to perform the redo operation is received, the document editing apparatus 10 perform the redo operation by tracing back only the history data of the editing operation performed in the range (a page or a part enlarged and displayed in the page) displayed on the page display area 21 of the display unit 15 when the instruction of the redo operation is received, in time sequence.

For example, a first page is displayed and a first editing operation is performed in the first page, and then a second page is displayed and a second editing operation is performed in the second page. Thereafter, when the first page is displayed and the undo operation is instructed, the first editing operation is undone.

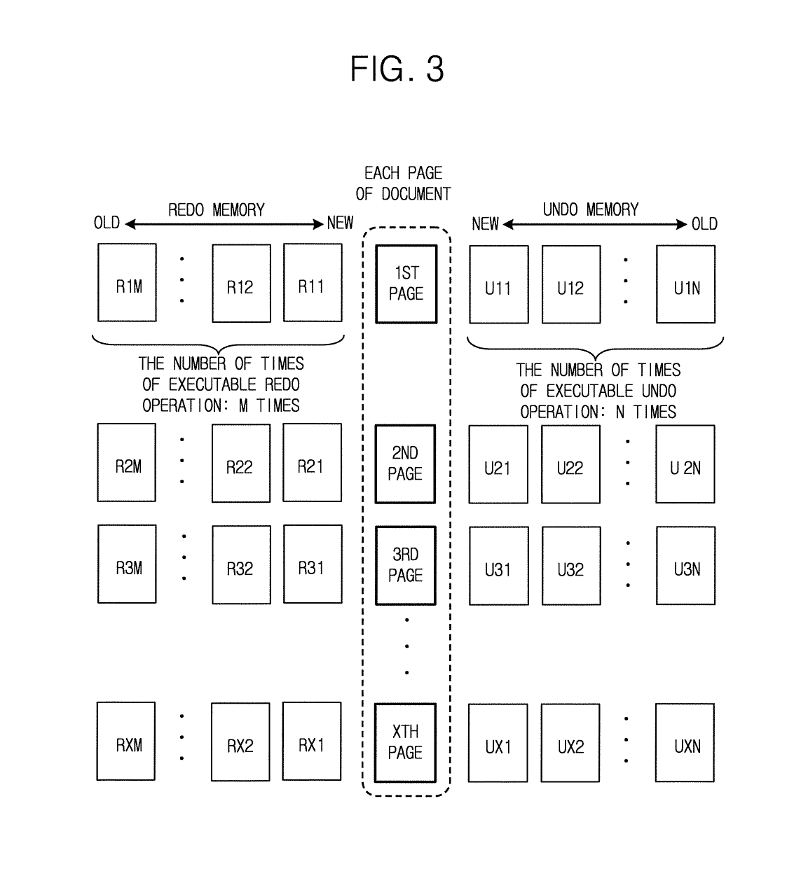

FIG. 3 shows a configuration example of the undo memory and the redo memory as the storage unit which stores the history data of the editing operation in the document. In the example of FIG. 3, the undo memory and the redo memory are provided for each page, and the editing history data can be stored for each page. For example, in case that the document to be edited by the document editing apparatus 10 has X pages, the undo memory and the redo memory for storing the editing history data for X pages are provided for each page.

The undo memory is a memory in which the history data indicating the contents of the editing operations received from the user are stored in time sequence within N history data from the newest editing operation as an upper limit. The redo memory is a memory in which the history data indicating the contents of the editing operations canceled by the undo operation are stored in time sequence within M history data from the newest undo operation as an upper limit.

In each page, the upper limit of the number of times of the executable undo operation is N and the upper limit of the number of times of the executable redo operation is M. Here, N and M are each optional positive integer.

For example, in case that the history data stored in the undo memory for the first page are U11, U12, . . . in the order from the newest history data, the oldest history data stored in the undo memory for the first page is U1N. In the undo memory for the first page, the history data from U11 to U1N are held. On the other hand, the data which are older than U1N (the data having the data number of N+1 or more) are not held.

Likewise, for example, in case that the history data stored in the redo memory for the first page are R11, R12, . . . in the order from the newest history data, the oldest history data stored in the redo memory for the first page is R1M. In the redo memory for the first page, the history data from R11 to R1M are held. On the other hand, data which are older than R1M (the data having the data number of M+1 or more) are not held. Here, the first number following the character “U” or “R” indicates the page number, and the second number is the number indicating the old and the new of the history data.

In this embodiment, a handwriting input is performed as the editing operation. Further, the contents of each stroke, which are added or deleted by the handwriting input are stored as the history data indicating the contents of each editing operation.

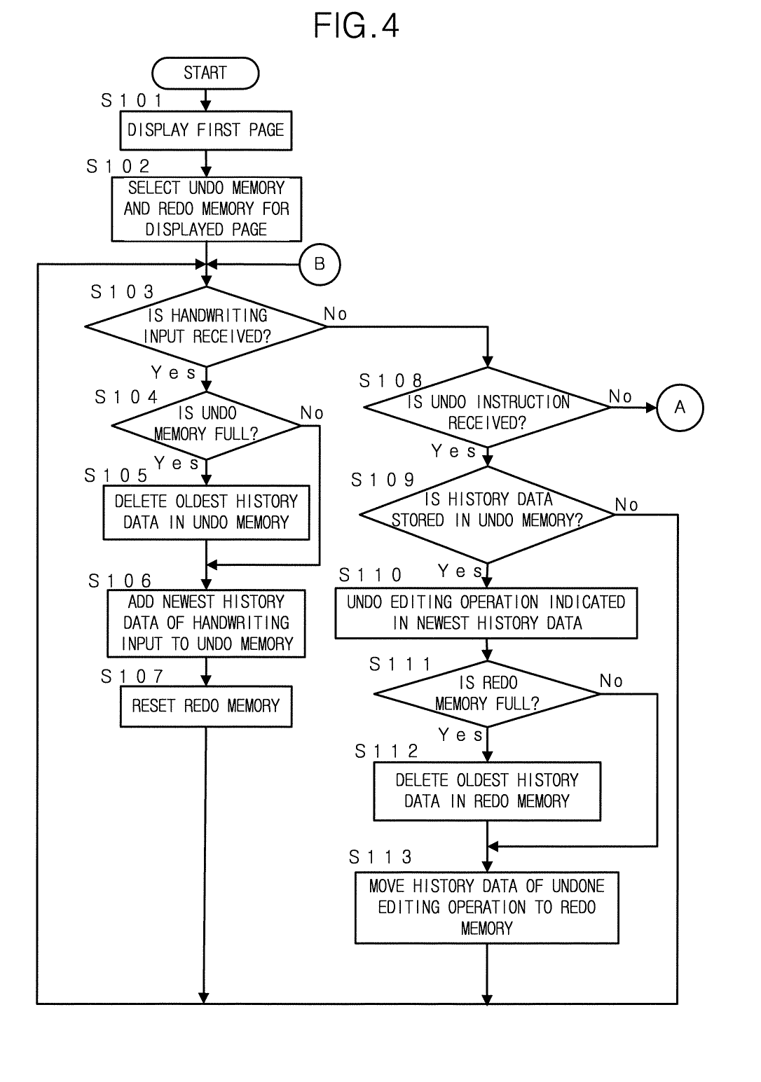

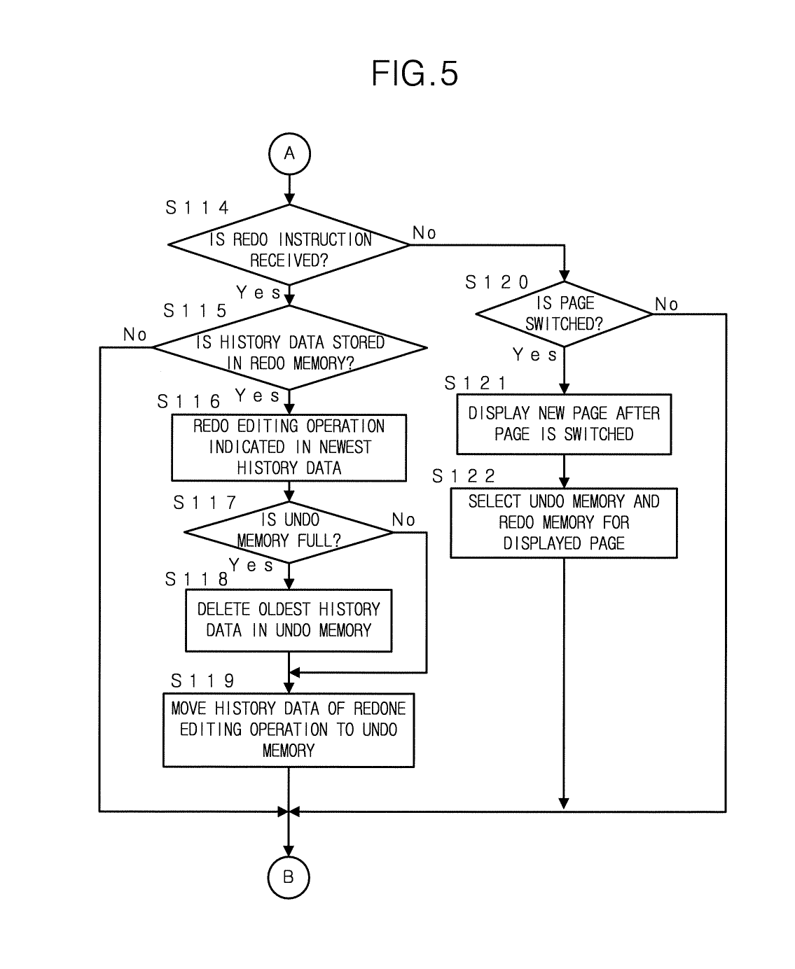

FIGS. 4 and 5 show the flowchart of the process relating to the undo operation and the redo operation during the handwriting input, which is performed by the document editing apparatus 10. First, when a document to be displayed is selected, a first page of the document is displayed (Step S101), and the undo memory and the redo memory for the displayed page are selected (Step S102).

When a handwriting input is received (Step S103; Yes), it is determined whether the selected undo memory for the displayed page is full (Step S104). For example, in case that the upper limit of the number of the history data to be stored in the undo memory is set to N, when N history data are already stored in the undo memory, the undo memory is full.

In case that the selected undo memory for the displayed page is not full (Step S104; No), the process proceeds to Step S106. In case that the selected undo memory for the displayed page is full (Step S104; Yes), the oldest history data stored in the undo memory is deleted (Step S105) and the process proceeds to Step S106.

In Step S106, the history data indicating the contents of the newest handwriting input is additionally stored in the selected undo memory for the displayed page. Then, all of the contents stored in the selected redo memory for the displayed page are reset (deleted) (Step S107), and the process returns to Step S103 and is continued.

In case that the undo button 26 is operated and the instruction to perform the undo operation is received from the user (Step S103; No and Step S108; Yes), it is determined whether the history data is stored in the selected undo memory for the displayed page (Step S109).

In case that the history data is not stored in the selected undo memory for the displayed page (Step S109; No), the editing operation (handwriting input) to be undone is not present. Therefore, the process returns to Step S103 and is continued.

In case that the history data is stored in the selected undo memory for the displayed page (Step S109; Yes), the undo operation is performed in accordance with the newest history data stored in the undo memory (Step S110).

Next, it is determined whether the selected redo memory for the displayed page is full (Step S111). In case that the selected redo memory for the displayed page is not full (Step S111; No), the process proceeds to Step S113. For example, in case that the upper limit of the number of the history data to be stored in the redo memory is set to M, when M history data are already stored in the redo memory, the redo memory is full.

In case that the selected redo memory for the displayed page is full (Step S111; Yes), the oldest history data stored in the redo memory is deleted (Step S112), and the process proceeds to Step S113.

In Step S113, the history data used in the undo operation of Step S110 is moved to the selected redo memory for the displayed page and is stored therein. Thereafter, the process returns to Step S103 and is continued.

In case that the redo button 27 is operated and the instruction to perform the redo operation is received from the user (Step S108; No and Step S114; Yes), it is determined whether the history data is stored in the selected redo memory for the displayed page (Step S115).

In case that the history data is not stored in the redo memory (Step S115; No), the editing operation to be redone is not present, and therefore the process returns to Step S103 and is continued.

In case that the history data is stored in the selected redo memory for the displayed page (Step S115; Yes), the redo operation is performed in accordance with the newest history data stored in the redo memory (Step S116). Next, it is determined whether the selected undo memory for the displayed page is full (Step S117). In case that the selected undo memory for the displayed page is not full (Step S117; No), the process proceeds to Step S119. In case that the selected undo memory for the displayed page is full (Step S117; Yes), the oldest history data stored in the undo memory is deleted (Step S118), and the process proceeds to Step S119.

In Step S119, the history data used in the redo operation of Step S116 is moved to the selected undo memory for the displayed page and is stored therein. Thereafter, the process returns to Step S103 and is continued.

In case that the page turning button 28 is operated and the instruction to switch the page is received from the user (Step S114; No and Step S120; Yes), the page displayed on the page display area 21 of the display unit 15 is switched in accordance with the instruction to switch the page (Step S121). Further, the undo memory and the redo memory for a page displayed after the page is switched are selected (Step S122). Thereafter, the process returns to Step S103 and is continued. In case that the instruction to switch the page is not received (Step S120; No), the process returns to Step S103 and is continued.

As described above, the document editing apparatus 10 has the undo memory and the redo memory for each page, and when the displayed page is switched, the undo memory and the redo memory for a page displayed after the page is switched are selected and are activated. Accordingly, for example, in case that that the editing operation is performed in the first page and then the page to be displayed is switched to the second page and the editing operation is performed in the second page, when a user is aware of an error in the contents of the editing operation which has been previously performed in the first page, the first page is displayed and the undo button 26 is operated. Therefore, the editing operation performed in the first page can be undone without undoing the editing operation performed in the second page. Even if the displayed page is switched, the contents stored in the undo memory and the redo memory for each page are held.

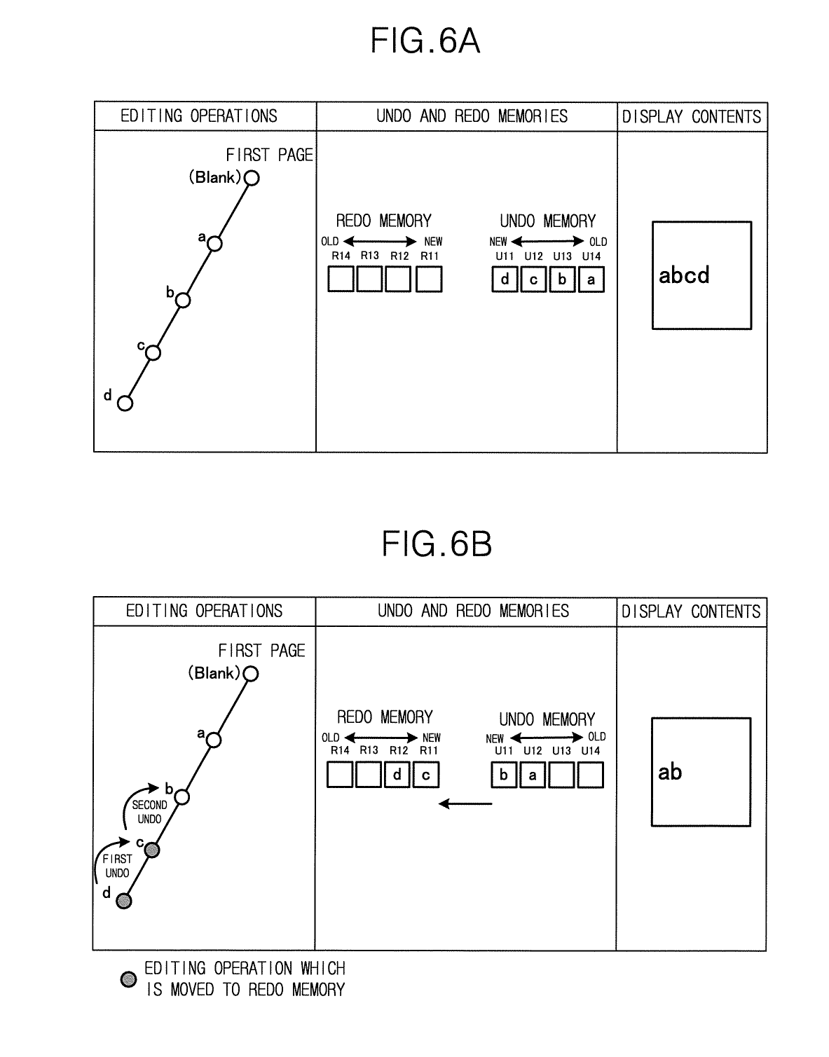

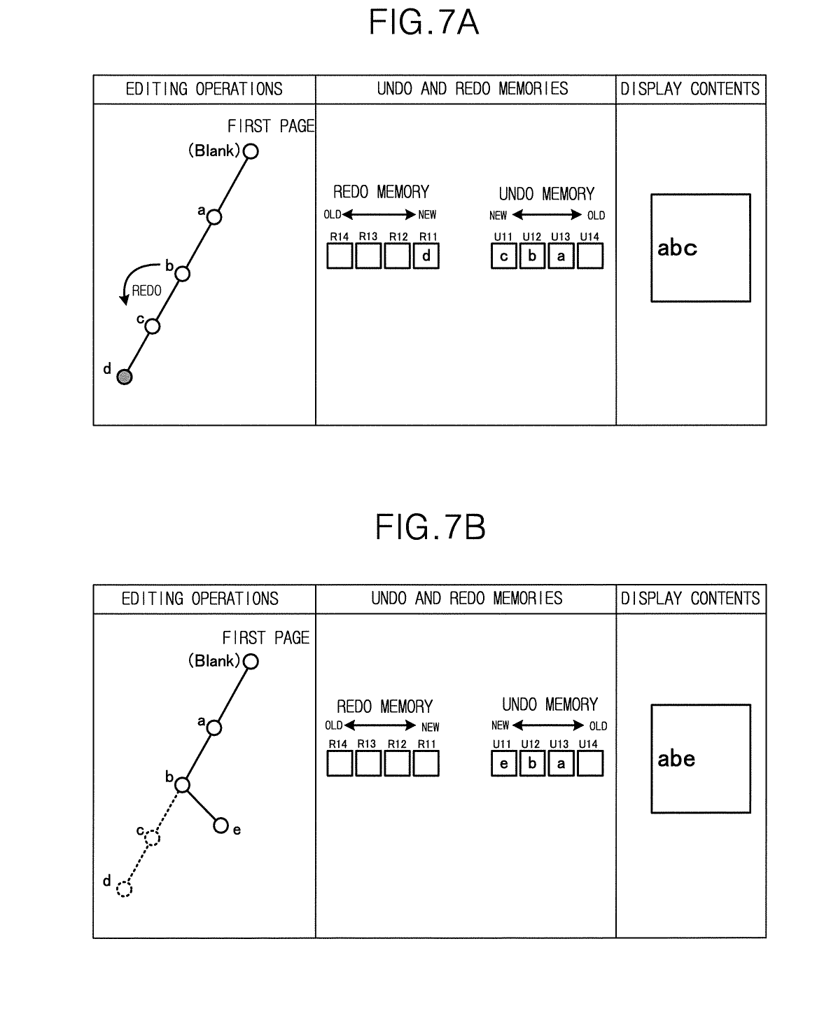

Next, a specific example of the operations in case that the undo operation and the redo operation are performed in a certain page will be explained with reference to FIGS. 6A, 6B, 7A and 7B.

In FIGS. 6A, 6B, 7A and 7B, in the column of the editing operation, the contents of the handwriting input received from the user are simulatedly displayed in time sequence. Further, in the column of the undo and redo memories, the contents which are currently stored in the undo memory and the redo memory are shown. In the column of the display contents, the display contents which are currently displayed on the page display area 21 are shown.

FIG. 6A shows the case in which a stroke “a”, a stroke “b”, a stroke “c”, and a stroke “d” are input in handwriting in this order in a first blank page. Further, in the column of the display contents, the display contents of each stroke are indicated by a character corresponding to a reference mark which is allocated to the stroke, for example, by using a character “a” for the stroke “a” and a character “b” for the stroke “b”.

The stroke “a” is stored in U14 of the undo memory, the stroke “b” is stored in U13 of the undo memory, the stroke “c” is stored in U12 of the undo memory, and the stroke “d” are stored in U11 of the undo memory. The display contents are “abcd”.

FIG. 6B shows the case in which the undo operation is continuously received twice in the state shown in FIG. 6A. The stroke “a” is moved to U12 of the undo memory and is stored therein, the stroke “b” is moved to U11 of the undo memory and is stored therein, the stroke “c” is moved to R11 of the redo memory and is stored therein, and the stroke “d” is moved to R12 of the redo memory and is stored therein. The stroke “d” and the stroke “c” are deleted from the display contents, and the display contents are “ab”.

When the redo operation is received once in the state of FIG. 6B, the state shown in FIG. 7A is obtained. The stroke “a” is moved to U13 of the undo memory and is stored therein, the stroke “b” is moved to U12 of the undo memory and is stored therein, the stroke “c” is moved to U11 of the undo memory and is stored therein, and the stroke “d” is moved to R11 of the redo memory and is stored therein. The stroke “c” is restored in the display contents and the display contents are “abc”.

When a new stroke is added in the state of FIG. 6B, the state shown in FIG. 6B is changed to the state shown in FIG. 7B. The redo memory is reset. That is, the history data of the strokes “c” and “d” stored in the redo memory are deleted. A new stroke “e” is added in the undo memory. As a result, the stroke “a” is moved to U13 of the undo memory, the stroke “b” is moved to U12 of the undo memory, and the stroke “e” is stored in U11 of the undo memory. The stroke “e” is added in the display contents and the display contents are “abe”.

Further, the history data are stored in a nonvolatile memory in which the stored contents are held even if a power supply is turned off. Therefore, even if the power supply of the document editing apparatus 10 is turned off or on, the history data are held. Accordingly, when the power supply of the document editing apparatus 10 is turned off or on, the undo operation and the redo operation for the editing operation performed before the power supply is turned off can be performed after the power supply is turned on. For example, the undo operation and the redo operation for the editing operations performed on the different edition dates can be performed.

Next, the case in which the function of enlarging and displaying a part of a certain page on the page display area 21 of the display unit 15 is added to the document editing apparatus 10 will be explained.

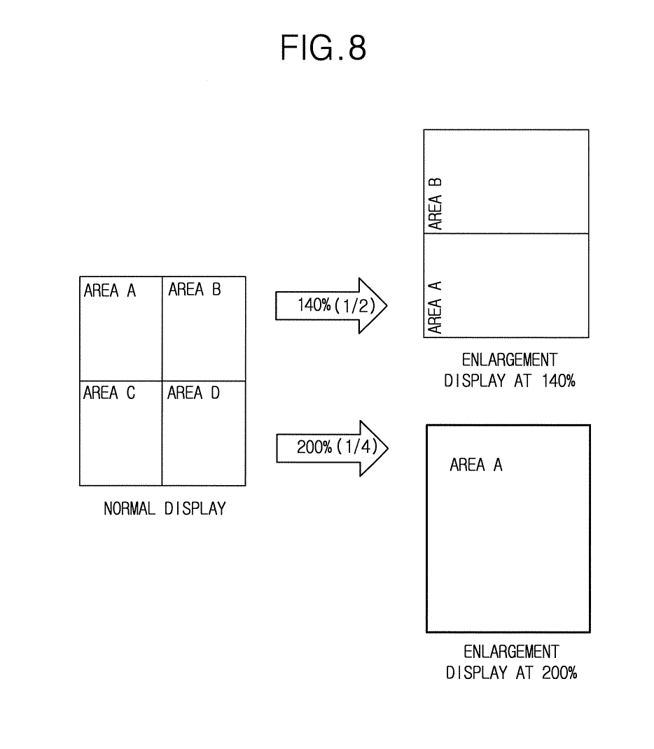

FIG. 8 shows an example of the display range in case that the normal display is performed and an example of the display range in case that the enlargement display is performed in the document editing apparatus 10. The document editing apparatus 10 can display the contents by switching the enlargement ratio among the normal display having the enlargement ratio of 100% (no enlargement), the enlargement display having the enlargement ratio of 140%, and the enlargement display having the enlargement ratio of 200%.

In the state of the normal display (having the enlargement ratio of 100%), a whole one page is just displayed on the whole of the page display area 21. The page display area 21 of the display unit 15 is managed by quartering the page display area 21 into four rectangular areas A, B, C, and D. In the state of the normal display (having the enlargement ratio of 100%), a range of a quarter of one page is displayed on each of the areas A, B, C, and D.

In the state of the enlargement display having the enlargement ratio of 140%, only the contents displayed on the areas A and B in the state of the normal display (having the enlargement ratio of 100%) are enlarged at 140% and displayed on the page display area 21, respectively. In the state of the enlargement display having the enlargement ratio of 200%, only the contents displayed on the area A in the state of the normal display (having the enlargement ratio of 100%) are enlarged at 200% and displayed on the page display area 21.

Further, in the enlargement display having the enlargement ratio of 140%, the areas C and D can be selected as the display range. In addition, in the enlargement display having the enlargement ratio of 200%, only the area B, only the area C, or only the area D can be selected as the display range.

The document editing apparatus 10 having the enlargement display function comprises the undo memory and the redo memory for each page as described above. Further, the undo memory and the redo memory for each page are managed by dividing the memories into the areas A, B, C, and D, respectively. That is, the document editing apparatus 10 comprises the undo memory and the redo memory for the area A, the undo memory and the redo memory for the area B, the undo memory and the redo memory for the area C, and the undo memory and the redo memory for the area D, with respect to one page.

The document editing apparatus 10 activates only the undo memory and the redo memory for the area displayed on the page display area 21. In the state of the normal display, all the undo memories and the redo memories for the areas A, B, C, and D are activated. In the enlargement display having the enlargement ratio of 140%, only the undo memories and the redo memories for the areas A and B (or the areas C and D) are activated. In the enlargement display of the enlargement ratio of 200%, only the undo memory and the redo memory for one area which is currently displayed among the areas A, B, C, and D are activated.

To each history data stored in the undo memory and the redo memory, the time information indicating the time at which the handwriting input corresponding to the history data is received (the input of the stroke is received), is added. For example, the time information includes Christian year, month, day, hour, minute and second. The time information may be information for specifying the order of the handwriting input, for example, the serial number and the like which is incremented by one whenever the handwriting input is received.

Further, the stroke of each handwriting input is assigned to the area in which the starting point of the stroke is included.

When the handwriting input is received, the document editing apparatus 10 creates the history data including the time information indicating the time at which the handwriting input is received. Further, the document editing apparatus 10 stores the history data in the undo memory for the area including the starting point of the stroke in the handwriting input.

When the instruction to perform the undo operation is received from the user, the document editing apparatus 10 selects the history data having the time information indicating the latest time among the history data stored in the undo memories which are currently activated, that is, the undo memories for the displayed areas, and undoes the editing operation indicated in the selected history data. Then, the document editing apparatus 10 moves the history data to the redo memory for the area for which the undo memory has stored the above history data.

Likewise, when the instruction of the redo operation is received from the user, the document editing apparatus 10 selects the history data having the time information indicating the latest time among the history data stored in the redo memories for the displayed areas, and redoes the editing operation indicated in the selected history data. Then, the document editing apparatus 10 moves the history data to the undo memory for the area for which the redo memory has stored the above history data.

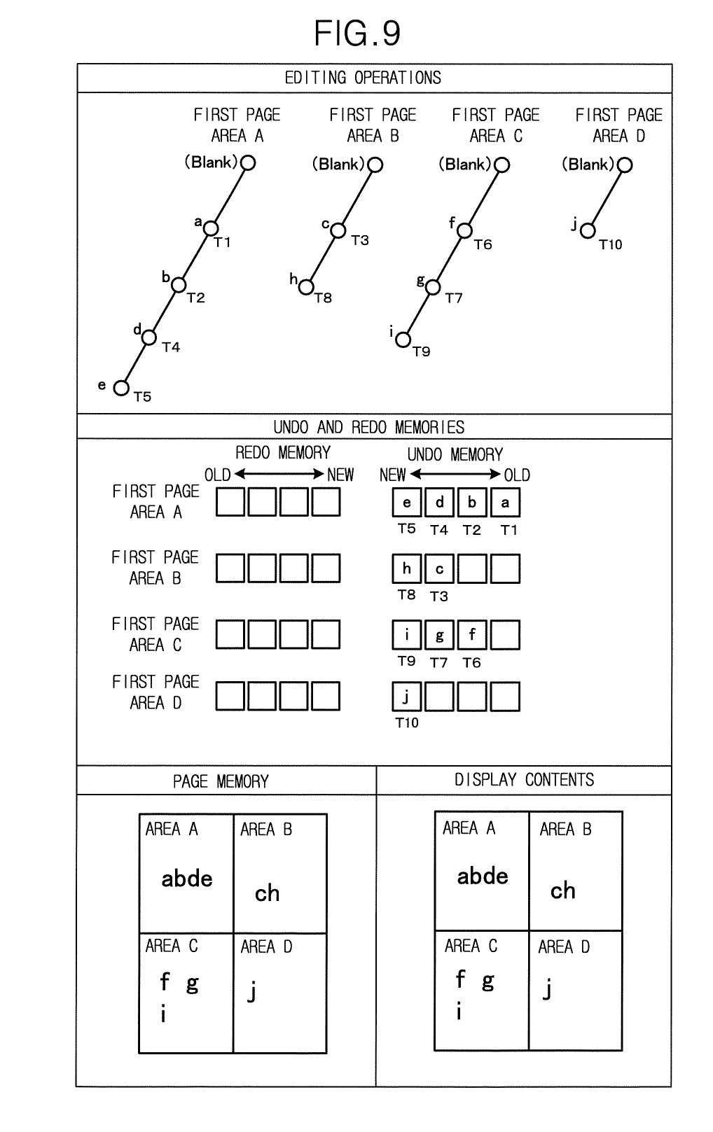

Next, a specific example of the operations in case that the undo operation and the redo operation are performed by the document editing apparatus 10 having the enlargement display function, will be explained with reference to FIGS. 9 to 16.

In the column of the editing operation, the handwriting input received from the user is divided into the areas A, B, C, and D, and simulatedly displayed in time sequence. In the column of the undo and redo memories, the contents which are currently stored in the undo memory and the redo memory for each of the areas A, B, C, and D are shown. In the column of the page memory, the current contents of the whole page are shown. In the column of the display contents, the display contents which are currently displayed on the page display area 21 are shown.

In this specific example, the editing operation is performed in the first page of the document. Further, the time information is indicated by T1, T2, . . . . As the attached number is smaller, the editing operation is order. Further, in the column of the page memory and the column of the display contents, the display contents of each stroke are indicated by a character corresponding to a reference mark which is allocated to the stroke, for example, by using a character “a” for the stroke “a” and a character “b” for the stroke “b”.

FIG. 9 shows the state in which 10 strokes have been input in handwriting from the stroke “a” to the stroke “j” in order in the state of the normal display. In this example, the stroke “a” having the starting point included in the area A is firstly input in handwriting (T1). The stroke “b” having the starting point included in the area A is continuously input in handwriting (T2). The stroke “c” having the starting point included in the area B is continuously input in handwriting (T3). The stroke “d” having the starting point included in the area A is continuously input in handwriting (T4). The stroke “e” having the starting point included in the area A is continuously input in handwriting (T5). The stroke “f” having the starting point included in the area C is continuously input in handwriting (T6). The stroke “g” having the starting point included in the area C is continuously input in handwriting (T7). The stroke “h” having the starting point included in the area B is continuously input in handwriting (T8). The stroke “i” having the starting point included in the area C is continuously input in handwriting (T9). The stroke “j” having the starting point included in the area D is finally input in handwriting (T10).

In the state of the normal display, all of the undo memories and the redo memories for the areas A to ID displayed on the page display area 21 are activated. The history data of each stroke is stored in the undo memory for the area including the starting point of each stroke, in the order of the handwriting input.

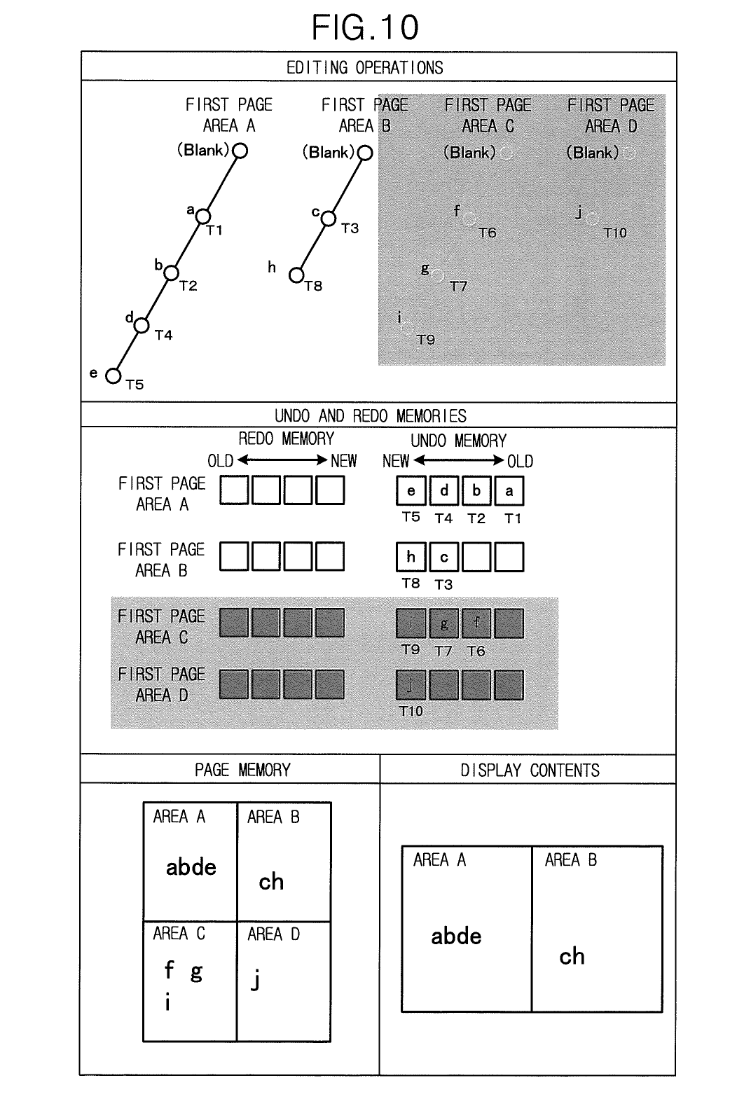

FIG. 10 shows the case in which only the areas A and B are enlarged at 140% in the state shown in FIG. 9 and are displayed. When only the areas A and B are enlarged at 140% and are displayed, only the areas A and B are enlarged and displayed on the page display area 21 and only the undo memories and the redo memories for the areas A and B are activated. The undo memories and the redo memories for the areas C and D which are not displayed on the page display area 21 are not activated. In this example, in the column of the editing operation and in the column of the undo and redo memories, the areas for which the memories are not activated are masked by a semitransparent gray color.

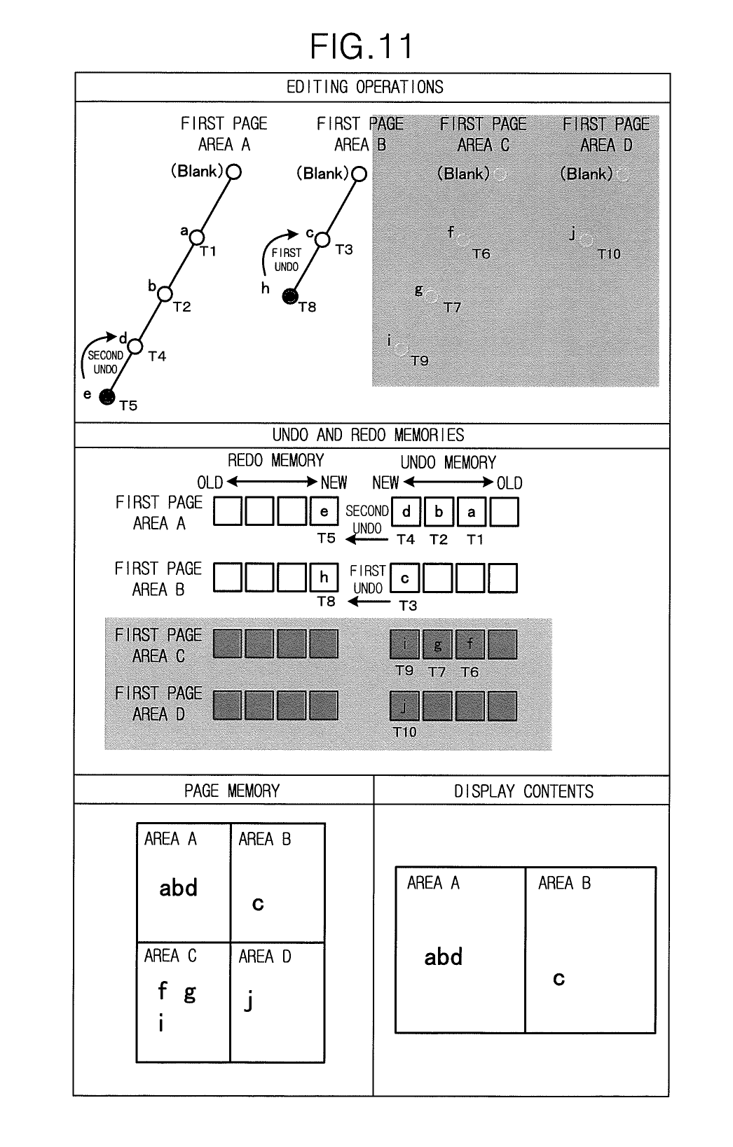

FIG. 11 shows the case in which the undo operation is continuously received twice in the state shown in FIG. 10. Because the newest editing operation in the history data stored in the undo memories for the areas A and B is the stroke “h” having the time information of T8, the stroke “h” is canceled from the area B of the page memory by the first undo operation. Then, the history data of the stroke “h” is moved from the undo memory for the area B to the redo memory for the area B.

After the above history data is moved, because the newest editing operation in the history data stored in the undo memories for the areas A and B is the stroke “e” having the time information of T5, the stroke “e” is canceled from the area A of the page memory by the second undo operation. Then, the history data of the stroke “e” is moved from the undo memory for the area A to the redo memory for the area A.

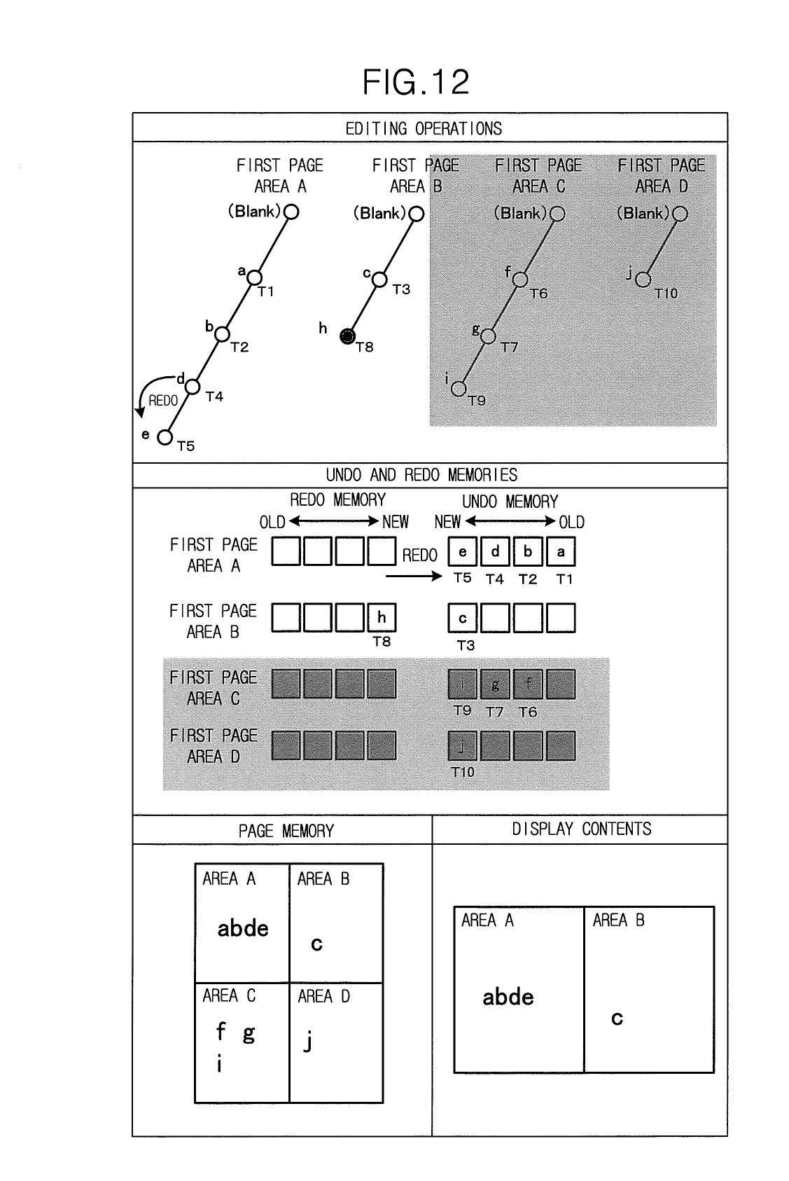

FIG. 12 shows the case in which the redo operation is received once in the state shown in FIG. 11. The history data indicating the newest undo operation in the history data stored in the activated redo memories for the areas A and B is the history data having the time information indicating the earliest time. In the example of FIG. 11, the history data having the time information indicating the earliest time among the history data stored in the redo memories for the areas A and B is the stroke “e” having the time information of T5. Accordingly, as shown in FIG. 12, the stroke “e” is drawn again in the area A of the page memory by the received redo operation. Further, the history data of the stroke “e” is moved from the redo memory for the area A to the undo memory for the area A.

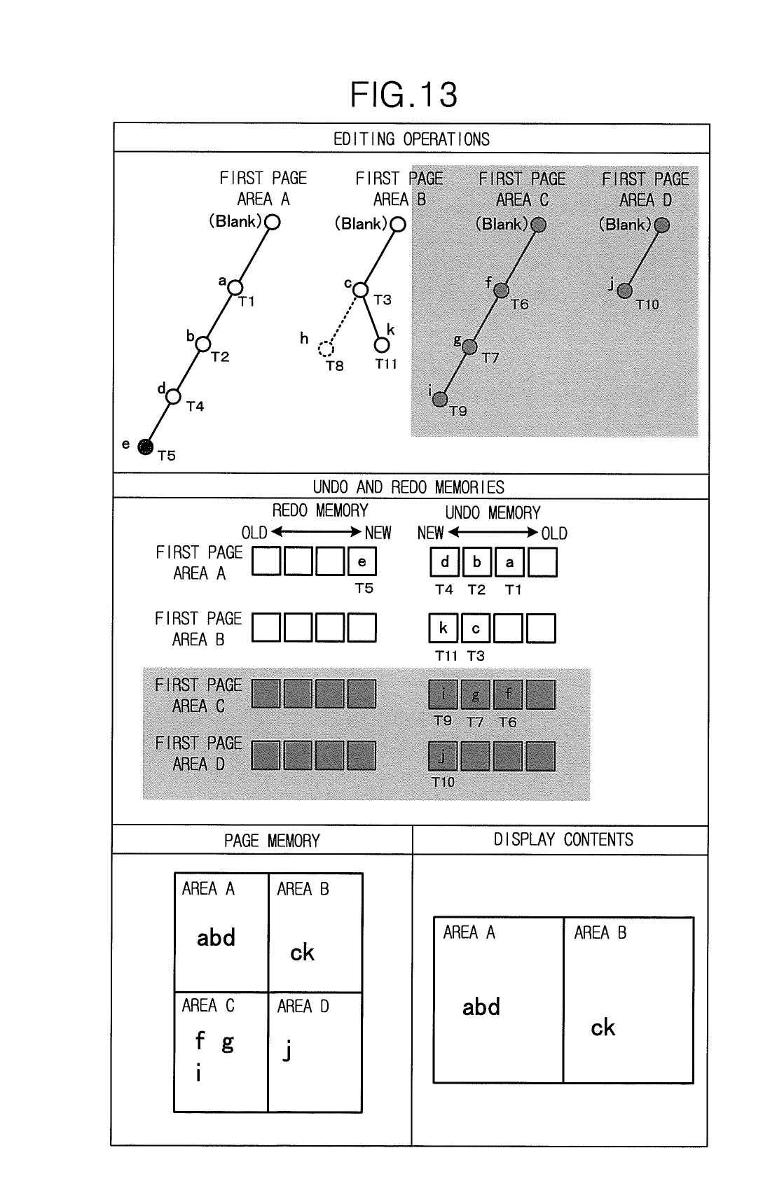

FIG. 13 shows the case in which a new stroke “k” is input in handwriting in the area B in the state shown in FIG. 11. The history data (including the time information T11) of the stroke “k” is added to the undo memory for the area B. Further, the redo memory for the area B is reset and the history data stored in the redo memory for the area B is deleted.

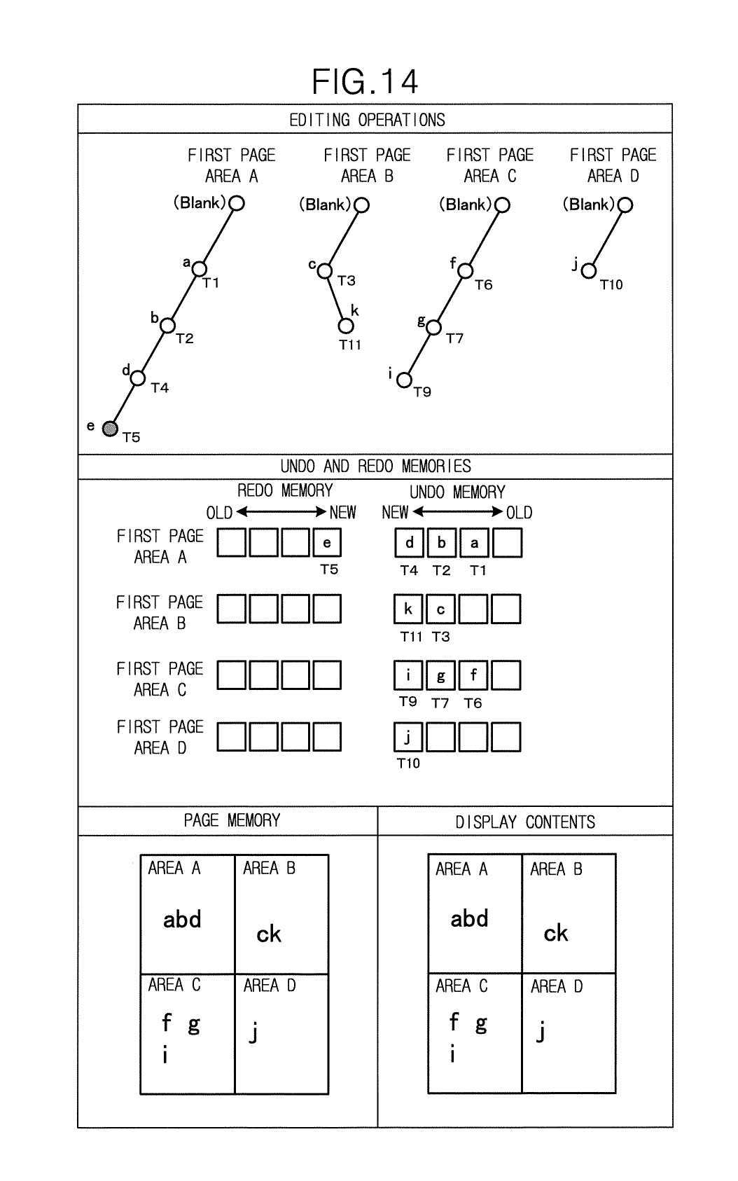

FIG. 14 shows the case in which the display state is returned to the normal display in the state shown in FIG. 13. All the areas A to D are displayed on the page display area 21. Further, all of the undo memories and the redo memories for the areas A to D are activated. The contents of the undo memories and the redo memories of the areas C and D are held also while the undo memories and the redo memories for the areas C and D are not activated, and the state of the undo memories and the redo memories which are activated is the same as the state of the undo memories and the redo memories just before the undo memories and the redo memories are not activated.

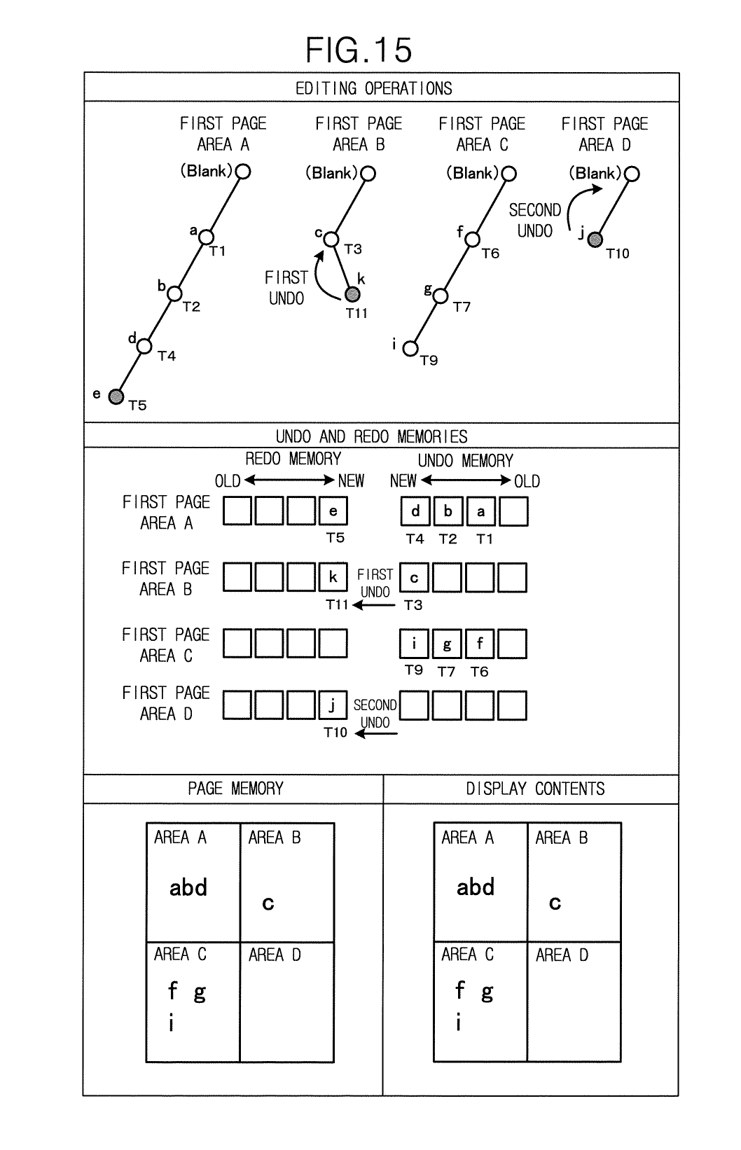

FIG. 15 shows the case in which the undo operation is continuously received twice in the state shown in FIG. 14. In the state of FIG. 14, because the newest editing operation in the history data stored in the undo memories for the areas A to D is the stroke “k” having the time information of T11, the stroke “k” is canceled from the area B of the page memory by the first undo operation. Then, the history data of the stroke “k” is moved from the undo memory for the area B to the redo memory for the area B.

After the above history data is moved, because the newest editing operation in the history data stored in the undo memories for the areas A to D is the stroke “j” having the time information of T10, the stroke “j” is canceled from the area D of the page memory by the second undo operation. Then, the history data of the stroke “j” is moved from the undo memory for the area D to the redo memory for the area D.

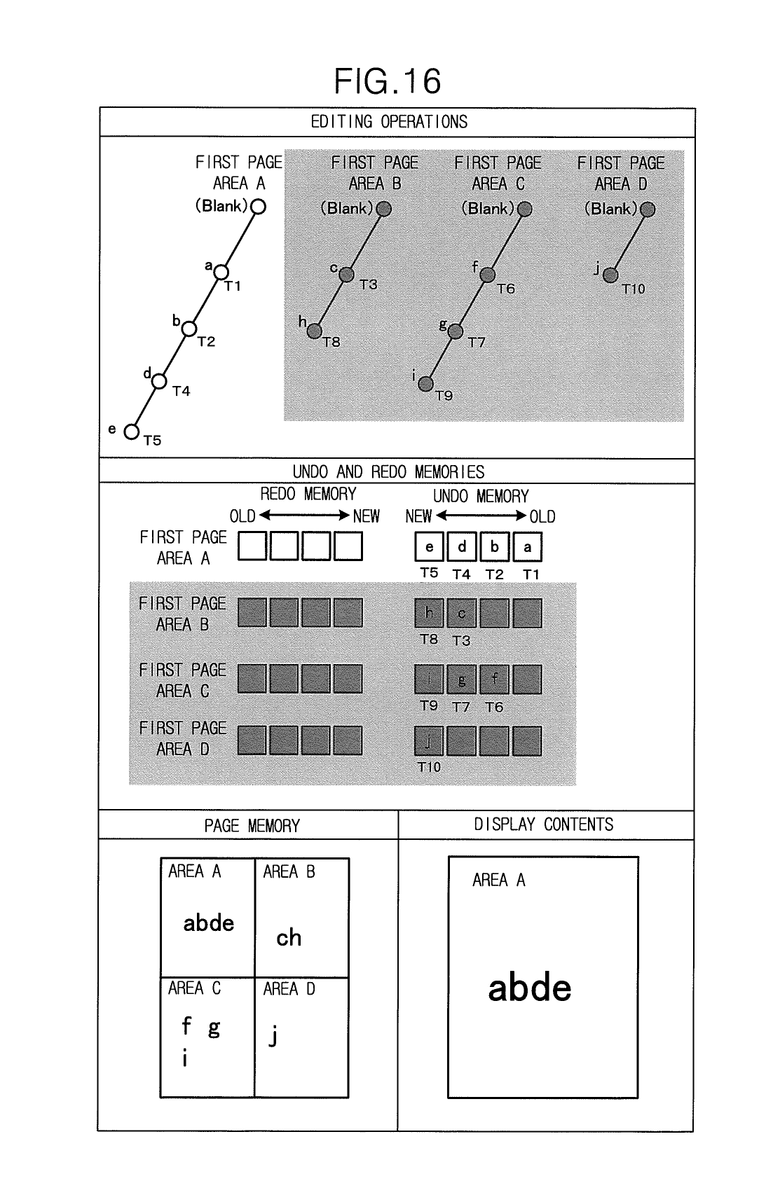

FIG. 16 shows the case in which only the area A is enlarged at 200% in the state shown in FIG. 9 and is displayed. In case that the enlargement display is canceled after the undo operation, the redo operation and the addition of the stroke are performed in the area A, the display state of the area A is the same as the display state of the area A before the enlargement display is canceled. Further, each display state of the areas B to D is the same as each display state of the areas B to D before the area A is enlarged and displayed.

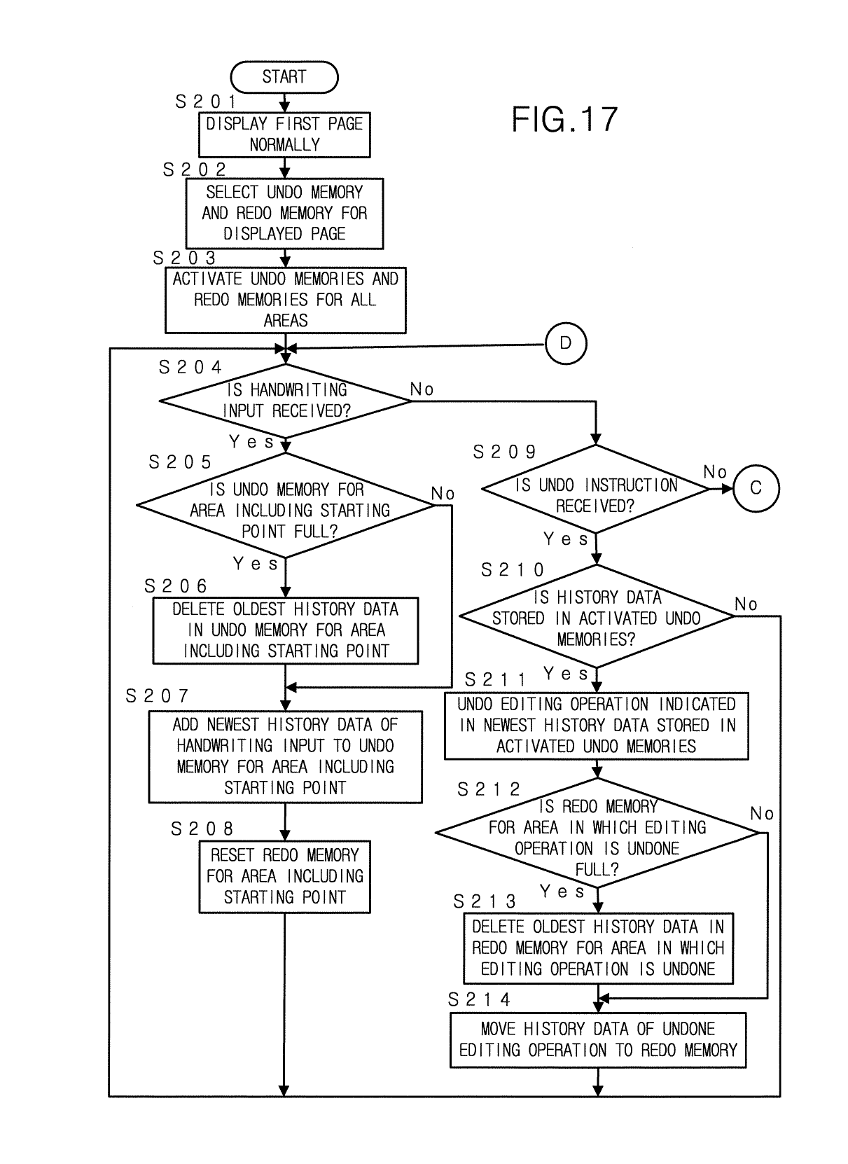

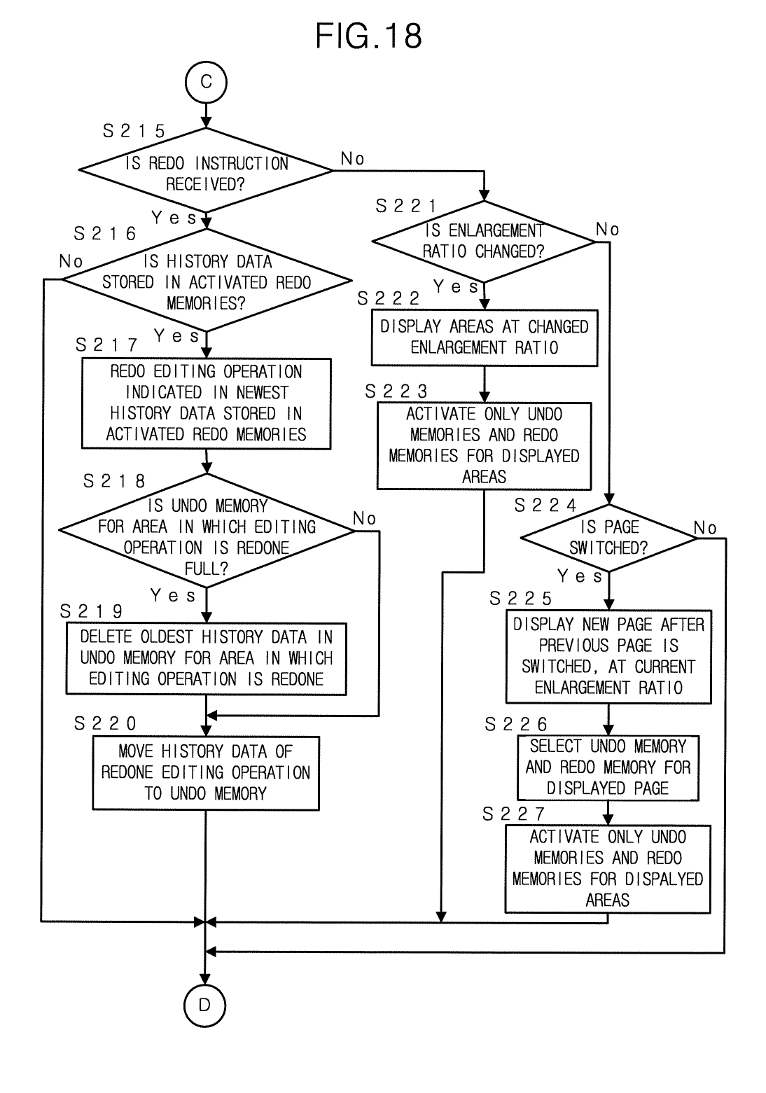

FIGS. 17 and 18 show the process relating to the undo operation and the redo operation during the handwriting input, which is performed by the document editing apparatus 10 having the enlargement display function. First, the first page of the document is normally displayed (Step S201), and the undo memories and the redo memories for all the areas (A to D) in the page which is normally displayed are selected (Step S202). Further, the undo memories and the redo memories for all the areas are activated (Step S203).

When a handwriting input is received (Step S204; Yes), it is determined whether the undo memory for the area including the starting point of the stroke in the handwriting input is full (Step S205). In case that the undo memory for the area including the starting point is not full (Step S205; No), the process proceeds to Step S207. In case that the undo memory is full (Step S205; Yes), the oldest history data stored in the undo memory for the area including the starting point is deleted (Step S206), and the process proceeds to Step S207.

In Step S207, the history data indicating the contents of the newest handwriting input (strokes) is additionally stored in the undo memory for the area including the starting point. The time information indicating the time at which the handwriting is performed is included in the history data. Next, all the contents stored in the redo memory for the area including the starting point are reset (deleted) (Step S208), the process returns to Step S204 and is continued.

In case that the undo button 26 is operated and the instruction to perform the undo operation is received from the user (Step S204; No and Step S209; Yes), it is determined whether the history data is stored in the activated undo memories for the displayed area (for example, the areas A and B in case that the areas A and B are enlarged at 140% and displayed) (Step S210).

In case that the history data is not stored in the activated undo memories for the displayed areas (Step S210; No), the editing operation to be undone is not present. Therefore, the process returns to Step S204 and is continued.

In case that the history data is stored in the activated undo memories for the displayed areas (Step S210; Yes), the history data having the time information indicating the latest time is selected from the history data stored in the activated undo memories, and the undo operation is performed in accordance with the history data (Step S211). For example, in case that the areas A and B are enlarged at 140% and displayed, the history data having the time information indicating the latest time is selected from the history data stored in the undo memories for the areas A and B, and the undo operation is performed.

Next, it is determined whether the redo memory for the area for which the undo memory has stored the history data indicating the undone editing operation is full (Step S212). In case that the redo memory is not full (Step S212; No), the process proceeds to Step S214. In case that the redo memory is full (Step S212; Yes), the oldest history data stored in the redo memory is deleted (Step S213) and the process proceeds to Step S214.

In Step S214, the history data used in the undo operation of Step S211 is moved to the redo memory for the area for which the undo memory has stored the history data indicating the undone editing operation, and is stored therein. Thereafter, the process returns to Step S204 and is continued.

In case that the redo button 27 is operated and the instruction to perform the redo operation is received from the user (Step S209; No and Step S215; Yes), it is determined whether the history data is stored in the activated redo memories for the displayed areas (for example, the areas A and B in case that the areas A and B are enlarged at 140% and displayed) (Step S216).

In case that the history data is not stored in the activated redo memories for the displayed areas (Step S216; No), the editing operation to be redone is not present, and therefore the process returns to Step S204 and is continued.

In case that the history data is stored in the activated redo memory for the displayed area (Step S216; Yes), the redo operation is performed in accordance with the newest history data stored in the activated redo memories for the displayed areas (Step S217). For example, in case that the areas A and B are enlarged at 140% and displayed, the history data having the time information indicating the latest time is selected from the history data stored in the redo memories for the areas A and B, and the redo operation is performed.

Next, it is determined whether the undo memory for the area for which the redo memory has stored the history data indicating the redone editing operation is full (Step S218). In case that the undo memory is not full (Step S218; No), the process proceeds to Step S220. In case that the undo memory for the area for which the redo memory has stored the history data indicating the redone editing operation is full (Step S218; Yes), the oldest history data stored in the undo memory is deleted (Step S219), and the process proceeds to Step S220.

In Step S220, the history data used is the redo operation of Step S217 is moved to the undo memory for the area for which the redo memory has stored the history data indicating the redone editing operation, and is stored therein. Thereafter, the process returns to Step S204 and is continued.

In case that the enlargement ratio is changed (Step S215; No and Step S221; Yes), only the areas to be displayed at the changed enlargement ratio are displayed on the page display area 21 (Step S222). Further, only the undo memories and the redo memories for the displayed areas are activated (Step S223), and the process returns to Step S204 and is continued. For example, in case that the display state is switched so as to enlarge the area A at 200% and to display it, only the undo memory and the redo memory for the area A are activated.

In case that the page turning button 28 is operated and the instruction to switch the page is received from the user (Step S221; No and Step S224; Yes), the page to be displayed next is displayed on the page display area 21 of the display unit 15 at the current enlargement ratio in accordance with the instruction to switch the page (Step S225). For example, in case that only the area A is enlarged at 200% and displayed before the page is switched, only the area A of the next page to be displayed after the page is switched is enlarged at 200% and displayed. The undo memories and the redo memories for all the areas of the displayed page are selected (Step S226), and only the undo memories and the redo memories for the displayed areas are activated (Step S227). Thereafter, the process returns to Step S204 and is continued.

In case that the instruction to switch the page is not received (Step S224; No), the process returns to Step S204 and is continued.

As described above, the document editing apparatus 10 has the undo memory and the redo memory for each page and each area, and when the page to be displayed is switched and displayed, the undo memories and the redo memories for all the areas in the displayed page are selected. Further, when the enlargement ratio is changed, only the undo memory and the redo memory for the area displayed at the enlargement ratio are activated. Therefore, when the area which is a part of the page is enlarged and displayed, only the strokes having the starting points included in the enlarged and displayed area can be undone or redone without influencing the other areas.

Next, the setting of the upper limit of the number of the history data to be stored in the undo memory and the redo memory will be explained.

The document editing apparatus 10 comprises the undo memory and the redo memory for each page. Further, in case that the document editing apparatus 10 has the enlargement display function, the document editing apparatus 10 comprises the undo memory and the redo memory for each area. Therefore, as the number of pages of the document increases, the storage capacity to be secured as the undo memory and the redo memory increases. As a result, the storage capacity to be secured as the undo memory and the redo memory is changed according to the circumstances. In this embodiment, by changing the upper limit of the number of the history data which can be stored in the undo memory and the redo memory, the storage capacity is restricted. In the document editing apparatus 10, by adopting one method or the combination of two or more methods among the following methods, the upper limit is changed. In this embodiment, documents and the history data are stored by using a common memory.

(First Method) In accordance with the remaining capacity of the memory, the upper limit is changed. For example, in case that a given threshold (%) relating to the remaining capacity of the memory is set, when the remaining capacity of the memory is lower than the threshold (%), the upper limit of the number of times of the executable undo operation and the upper limit of the number of times of the executable redo operation in all pages are automatically decreased by 1. As a result, the situation in which the undo operation and the redo operation cannot be performed is prevented. The above thresholds (%) may be set in two or three stages.

(Second Method) The upper limit is changed in accordance with the number of pages of the documents stored in the memory. For example, in accordance with the number of pages of the documents held in the document editing apparatus 10 and the storage capacity which can be allocated to the history data in the remaining capacity of the memory, the upper limit of the number of times of the executable undo operation and the upper limit of the number of times of the executable redo operation in each page are automatically set.

Therefore, even in case that a plurality of files are transmitted from a PC terminal and the like to the document editing apparatus 10 and the number of pages held in the document editing apparatus 10 is increased, the upper limit of the number of times of the executable undo operation and the upper limit of the number of times of the executable redo operation can be automatically set to each suitable value. For example, a lookup table for outputting the upper limit of the number of times of the executable undo operation and the upper limit of the number of times of the executable redo operation in each page by inputting the remaining capacity and the number of pages, is prepared, and the upper limit which is suitable for the current situation is obtained with reference to the lookup table.

(Third Method) The upper limit of the number of times of the executable undo operation and the upper limit of the number of times of the executable redo operation in each page or each area are increased in accordance with the number of the objects which are added to the page or the area. For example, each upper limit is initially set to 3 operations in each page. Then, in case that the storage capacity can be allocated to the history data in the remaining capacity of the memory, every when an object such as a handwritten stroke is added, the upper limit of the number of times of the executable undo operation and the upper limit of the number of times of the executable redo operation in the page to which the object is added, are increased by 1.

Therefore, the number of times of the executable undo operation and the executable redo operation can be automatically changed in each page (or in each area). Further, it is possible to automatically increase the upper limit of the number of times of the executable undo operation and the upper limit of the number of times of the executable redo operation in a page (or an area) in which a user wants to write many objects, without requiring a special user's operation. The object is not limited to a handwritten stroke, and an arbitrary object, for example, a figure, a character to be input by using a character code, and the like may be written.

(Fourth Method) In accordance with the size of the blank portion which is initially included in a page, an area or the like, the upper limit of the number of the executable undo operation and the upper limit of the number of the executable redo operation in the page or the area are changed. For example, in case that a given threshold (%) relating to the blank portion included in one page is set, when the blank portion is more than the threshold (%) in a certain page, the upper limit of the number of times of the executable undo operation and the upper limit of the number of times of the executable redo operation are automatically increased by a given value. As a result, more undo and redo operations can be performed in a page in which the space for writing the objects is wide. The above blank portion is a blank portion which is included in a page or an area in an initial state of the document when the document is loaded from an external PC terminal or the like to the document editing apparatus 10.

(Fifth Method) As the number of figures included in a page, an area, or the like is increased, the upper limit of the number of times of the executable undo operation and the upper limit of the number of times of the executable redo operation in the page or the area are decreased. Although symbols such as a circle mark are added to the figures, it is considered that the various objects are hardly written. Accordingly, in case that a given threshold (%) relating to the ratio of the figures in a page or an area is set, when the figures are drawn more than the threshold (%) in a certain page or area, the upper limit of the number of times of the executable undo operation and the upper limit of the number of times of the executable redo operation are automatically decreased by a given value. As a result, each storage area of the undo memory and the redo memory for the page or the area in which it is expected to write only a few objects can be decreased, and the memory can be used effectively.

In the first method and the second method, preferably, the same upper limit is set for all pages (or all areas). However, in case that the upper limit is set by combining other methods, the upper limit is set for each page or for each area. In the third method to the fifth method, the upper limit is set for each page (or for each area).

Next, the jump edit function of the document editing apparatus 10 will be explained.

The jump edit function is a function in which an arbitrary history data of the editing operation is selected from a list of the history data without tracing back the history data in order in time sequence and the editing operation indicated in the selected editing history data can be undone or redone.

In the document editing apparatus 10, an operation button for designating the jump edit function is provided on the tool bar 23. In the document editing apparatus 10, when the operation button is pressed down, the history data stored in the undo memory and the redo memory for the page or the area which is currently displayed on the page display area 21 is listed and is displayed in time sequence. When a specific history data is selected from the list by the user, the editing operation indicated in the history data is undone or redone. That is, in case that the selected history data is the history data stored in the undo memory, the editing contents indicated in the history data are undone. In case that the selected history data is the history data stored in the redo memory, the editing contents indicated in the history data are redone.

For example, when the history data of U13 is selected in the state shown in FIG. 7A, the editing contents indicated in the history data of U13 are undone. Specifically, the stroke “a” is deleted from the page display area 21. The history data stored in U13 is deleted or moved to the redo memory.

In the jump edit function, the task for performing the operation by the user increases. However, the editing operation indicated in arbitrary history data can be undone or redone independently of the other history data.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

In the embodiment, the case in which the editing operation is a handwriting input is explained. The editing operation to be stored as the history data is not limited to the handwriting input. However, the operation for switching the displayed area, such as the operation for switching the page or the operation for changing the enlargement ratio, is not included in the history data.

In the embodiment, the contents of the stroke which is input in handwriting are stored as one history data. However, the whole contents of the page or the area which is displayed when the editing operation is received may be stored as one history data. In this case, when the undo operation or the redo operation is performed, the display contents stored as the history data are directly displayed.

In the embodiment, the example in which the undo memory and the redo memory are set in separate memory areas and the history data is moved between the memory areas is explained. However, the undo memory and the redo memory may be configured in one common memory area.

In the embodiment, the document editing apparatus 10 which can receive the handwriting input is explained as an example. However, the document editing apparatus which does not have the handwriting input function may be provided. Further, by instructing the information processing apparatus to execute a predetermined program, the information processing apparatus may be operated as the document editing apparatus according to the embodiment.

In the embodiment, the example in which the enlargement display function is limited to the normal display, the enlargement display having the enlargement ratio of 140% and the enlargement display having the enlargement ratio of 200% is explained. However, the enlargement ratio can be arbitrarily set. In this case, for example, it is not necessary to provide the undo memory and the redo memory for each area, and the undo memory and the redo memory are provided for each page. Further, the position coordinate of the starting point of the stroke is included in each history data. In case that the undo operation or the redo operation is received when an arbitrary range in the page is displayed, only the history data in which the position coordinate of the starting point is included in the displayed range may be used for the undo operation and the redo operation, and the undo operation or the redo operation may be performed by using the history data selected in accordance with the time information from the history data to be used for the undo operation and the redo operation.

Further, in the embodiment having the function of the enlargement display, the history data of the stroke is assigned to the area including the starting point of the stroke and is stored in the undo memory and the redo memory for the area to which the history data is assigned. However, the criterion for the determining the area to which the history data is assigned is not limited to the starting point of the stroke. For example, in case that the stroke strides over a plurality of areas, the area including the most part of the stroke may be set to the area to which the stroke is assigned.

The upper limit is automatically changed. Alternatively, the user may arbitrarily change the setting of the upper limit.

In the embodiment, in case that after one editing operation is undone, another editing operation such as the handwriting input is received, the corresponding redo memory is reset. However, in another example, it is not necessary to reset the redo memory. That is, the history data indicating a new handwriting input received in the undone state is additionally stored in the undo memory, and the contents stored in the redo memory are held without deleting the data. In case of the handwriting input, unlike the case in which a text is input by using a character code, the respective strokes are arranged independently. Therefore, one handwriting input is not related to another. Accordingly, in case that the new handwriting input is received in the undone state, even if the redo memory is not reset, the display contents are not badly influenced.

In the embodiment, both of the document data and the history data are stored in the recording unit 12. Alternatively, a first storage unit and a second storage unit may be provided. Then, the document data may be stored in the first storage unit and the history data may be stored in the second storage unit, separately.

In the embodiment, the example in which an electronic paper which can hold the display contents without consumption of power and consumes the power when the display contents are rewritten is adopted as the display unit 15 is explained. However, the display unit is not limited to the above electronic paper, and a liquid crystal display or the like may be adopted.

One of the objects of the above embodiment is to provide a document editing apparatus, a non-transitory computer-readable recording medium and a document editing method which can undo or redo the editing operation which has been performed in the past in one displayed range without undoing the editing operation performed in another range which is currently displayed.

In the above embodiment, a range which is a part of the document (for example, a page) and which is displayed on the display unit can be switched, and only the editing operation performed in the range which is currently displayed is undone or redone.

In the above embodiment, the history data of the editing operation are stored for each range. As a result, a user can easily trace back only the history data of the editing operation performed in the range which is currently displayed.

In the embodiment, the range displayed on the display unit can be switched page by page, and the undo operation and the redo operation for the editing operation can be performed in each page.

In the above embodiment, for example, in case that the enlargement display is performed, only the area which is a part of the page is displayed on the display unit, and the undo operation and the redo operation are performed in only the area which is currently enlarged and displayed.

In the above embodiment, the undo operation and the redo operation can be performed only within the upper limit. In case that the history data of the editing operation are stored for each range (page or area), when the number of the pages or the number of the areas increases, the storage capacity to be secured in order to store the history data of the editing operation is increased. Therefore, by providing the upper limit of the number of times of the executable undo operation and the upper limit of the number of times of the executable redo operation, the increase in the storage capacity for storing the history data of the editing operation is prevented.

In the above embodiment, the upper limit can be changed. The upper limit may be changed manually, or may be changed automatically in accordance with the conditions of the apparatus or the like.

In the above embodiment, when the remaining capacity of the storage unit decreases, the upper limit of the number of times of the executable undo operation and the upper limit of the number of times of the executable redo operation in each page or each area are decreased. The situation in which the undo operation or the redo operation cannot be performed in a new page is prevented.

In the above embodiment, as the number of the pages of the document increases, the storage area of the storage unit is consumed. Therefore, the storage capacity which can be allocated to the history data to be stored is decreased. Further, as the number of the pages increases, the history data to be stored increases. In order to solve the above problem, the upper limit of the number of times of the executable undo operation and the upper limit of the number of times of the executable redo operation are increased or decreased in accordance with the number of the pages of the document stored in the storage unit.

In the above embodiment, as the number of the objects which are added in the page or the area increases, the upper limit of the number of times of the undo operation and the upper limit of the number of times of the redo operation increase. Therefore, more storage capacity of the memory can be allocated to the undo memory and the redo memory for the page or the area in which more editing operations are performed.

In the above embodiment, it is considered that as the initial blank portion is wider in the page or the area, more objects are added to the page or the area. Therefore, the upper limit is increased or decreased in accordance with the size of the initial blank portion.

In the above embodiment, it is considered that the number of the objects to be added to a figure is smaller than the number of the objects to be added to the blank portion or the document. Therefore, the upper limit of the number of times of the executable undo operation and the upper limit of the number of times of the executable redo operation in the page or the area in which more figures are drawn are decreased.

In the above embodiment, in the displayed range, an arbitrary editing operation can be undone or redone without tracing back the history data of the editing operation in time sequence.

In the above embodiment, even if the power supply is turned off or on, the undo operation and the redo operation for the editing operations which are performed before the power supply is turned off can be performed.

According to the document editing apparatus, the non-transitory computer-readable recording medium and the document editing method, the editing operation which has been performed in the past in one displayed range can be undone or redone without undoing the editing operation performed in another range which is currently displayed.

The present U.S. patent application claims the priority of Japanese Patent Application No. 2013-144180, filed on Jul. 10, 2013, according to the Paris Convention, and the entirety of which is incorporated herein by reference for correction of incorrect translation.

What is claimed is:

1. A document editing apparatus comprising:
a display unit configured to display a range which is a part of a document;
a displayed range switching unit configured to switch the range displayed on the display unit;
an operating unit configured to receive an editing operation for the document;
an editing unit configured to edit the document in accordance with the editing operation received by the operating unit;
a storage unit configured to store history data of the editing operation for the document; and
an undo and redo instruction unit configured to receive an instruction to perform an undo operation for the editing operation performed by the editing unit, and an instruction to perform a redo operation for the editing operation performed by the editing unit,
wherein in case that the undo and redo instruction unit receives the instruction to perform the undo operation, the editing unit performs the undo operation by tracing back only the history data of the editing operation performed in the range displayed on the display unit when the instruction to perform the undo operation is received, among the history data stored in the storage unit, and
in case that the undo and redo instruction unit receives the instruction to perform the redo operation, the editing unit performs the redo operation by tracing back only the history data of the editing operation performed in the range displayed on the display unit when the instruction to perform the redo operation is received, among the history data stored in the storage unit.

2. The document editing apparatus of claim 1, wherein the storage unit stores the history data for each range.

3. The document editing apparatus of claim 1, wherein the range is an arbitrary one page of the document.

4. The document editing apparatus of claim 1, wherein the range is an area which is a part of an arbitrary one page of the document.

5. The document editing apparatus of claim 1, wherein the editing operation includes a handwriting input.

6. The document editing apparatus of claim 1, wherein an upper limit of number of times of the undo operation in the range and an upper limit of number of times of the redo operation in the range are set.

7. The document editing apparatus of claim 6, further comprising an upper limit changing unit configured to change each of the upper limits.

8. The document editing apparatus of claim 7, wherein the upper limit changing unit changes each of the upper limits in accordance with a remaining capacity of the storage unit.

9. The document editing apparatus of claim 7, wherein the storage unit is used also as a storage area for storing the document, and
the upper limit changing unit changes each of the upper limits in accordance with number of pages of the document stored in the storage unit.

10. The document editing apparatus of claim 7, wherein each of the upper limits is set for each range, and the upper limit changing unit increases each of the upper limits set for an arbitrary range in accordance with number of objects added to the arbitrary range.

11. The document editing apparatus of claim 7, wherein each of the upper limits is set for each range, and the upper limit changing unit changes each of the upper limits set for an arbitrary range in accordance with a size of a blank portion which is initially included in the arbitrary range of the document.

12. The document editing apparatus of claim 7, wherein each of the upper limits is set for each range, and the upper limit changing unit decreases each of the upper limits set for an arbitrary range as number of figures included in the arbitrary range of the document increases.

13. The document editing apparatus of claim 1, wherein the undo and redo instruction unit has a function of receiving a selection of an arbitrary one history data from the history data stored in the storage unit, and
the editing unit has a function of undoing or redoing the editing operation corresponding to the selected one history data.

14. The document editing apparatus of claim 1, wherein the storage unit stores the history data in a nonvolatile manner.

15. A non-transitory computer-readable recording medium storing a program, wherein the program causes an information processing apparatus to function as the document editing apparatus of claim 1.

16. The non-transitory computer-readable recording medium of claim 15, wherein the storage unit stores the history data for each range.

17. The non-transitory computer-readable recording medium of claim 15, wherein the range is an arbitrary one page of the document.

18. A document editing method, comprising:
displaying a range which is a part of a document;
switching the displayed range;
receiving an editing operation for the document;
editing the document in accordance with the received editing operation;
storing history data of the editing operation for the document; and
receiving an instruction to perform an undo operation for the editing operation, and an instruction to perform a redo operation for the editing operation,
wherein in case that the instruction to perform the undo operation is received, the undo operation is performed by tracing back only the history data of the editing operation performed in the range displayed when the instruction to perform the undo operation is received, among the stored history data, and
in case that the instruction to perform the redo operation is received, the redo operation is performed by tracing back only the history data of the editing operation performed in the range displayed when the instruction to perform the redo operation is received, among the stored history data.

19. The document editing method of claim 18, wherein the history data is stored for each range.

20. The document editing method of claim 18, wherein the range is an arbitrary one page of the document.
